(19) United States
(12) Patent Application Publication
(10) Pub. No.: US 2024/0231807 A9
(43) Pub. Date: Jul. 11, 2024

(54) BIDIRECTIONAL VERSION COMPATIBILITY CONTROL

(71) Applicant: Dell Products L.P., Round Rock, TX (US)

(72) Inventors: Xueqiang ZHOU, Shanghai (CN); Carl SHI, Shanghai (CN); Shunhua XIE, Shanghai (CN); Xiaofeng ZHANG, Shanghai (CN); Steven CHEN, Shanghai (CN)

(73) Assignee: Dell Products L.P., Round Rock, TX (US)

(21) Appl. No.: 17/977,853

(22) Filed: Oct. 31, 2022

(30) Foreign Application Priority Data
Oct. 19, 2022 (CN) 202211278803.4

(51) Int. Cl. G06F 8/71; G06F 8/65

(52) U.S. Cl. CPC G06F 8/71; G06F 8/65

(57) ABSTRACT

An information handling system may include at least one processor and a memory. The information handling system may be configured to receive a request to upgrade a component from a first version to a second version; perform a first check by determining if allowed source release (ASR) information of the second version includes a reference to the first version; perform a second check by determining if allowed target release (ATR) information of the first version includes a reference to the second version; and in response to either of the first check and the second check being successful, perform the component upgrade.

### TECHNICAL FIELD

The present disclosure relates in general to information handling systems, and more particularly to techniques for managing different versions of a component in an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Various components of information handling systems sometimes need to be updated. For example, software and/or firmware components are often revised several times throughout their lives to fix bugs, address security vulnerabilities, add features, etc.

Different conventions are in use for specifying the version number of a component (e.g., semantic versioning, calendar versioning, build numbering, etc.). For the sake of concreteness, most of this disclosure discusses embodiments in the context of semantic version numbering, which specifies a version numerically as X.Y.Z, where X refers to a major version, Y refers to a minor version, and Z refers to a patch. However, one of ordinary skill in the art with the benefit of this disclosure will understand that it may be applied with respect to other version numbering standards as well.

In general, there are sometimes restrictions regarding whether one version can be upgraded to another. For example, sometimes the existing version of a component is too old to be upgraded directly to a given newer version, and so an intermediate version upgrade must be applied first.

In other situations, there may be certain minor or patch versions that can prevent a user from upgrading to a new major version. For example, suppose that version 1.0.201 is a very recent patch to major version 1 of a product. It may be impossible to upgrade that version to the 2.0.0 release, which is newer in major version, but older in time.

Embodiments of this disclosure thus provide improvements in the field of managing version compatibility issues.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with component versioning in information handling systems may be reduced or eliminated.

In accordance with embodiments of the present disclosure, an information handling system may include at least one processor and a memory. The information handling system may be configured to receive a request to upgrade a component from a first version to a second version; perform a first check by determining if allowed source release (ASR) information of the second version includes a reference to the first version; perform a second check by determining if allowed target release (ATR) information of the first version includes a reference to the second version; and in response to either of the first check and the second check being successful, perform the component upgrade.

In accordance with these and other embodiments of the present disclosure, a method may include an information handling system receiving a request to upgrade a component from a first version to a second version; the information handling system performing a first check by determining if allowed source release (ASR) information of the second version includes a reference to the first version; the information handling system performing a second check by determining if allowed target release (ATR) information of the first version includes a reference to the second version; and in response to either of the first check and the second check being successful, the information handling system performing the component upgrade.

In accordance with these and other embodiments of the present disclosure, an article of manufacture may include a non-transitory, computer-readable medium having computer-executable code thereon that is executable by a processor of an information handling system for: receiving a request to upgrade a component from a first version to a second version; performing a first check by determining if allowed source release (ASR) information of the second version includes a reference to the first version; performing a second check by determining if allowed target release (ATR) information of the first version includes a reference to the second version; and in response to either of the first check and the second check being successful, performing the component upgrade.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates an example unidirectional version upgrade scenario, in accordance with embodiments of the present disclosure; and

FIG. 3 illustrates an example bidirectional version upgrade scenario, in accordance with embodiments of the present disclosure.

### DETAILED DESCRIPTION

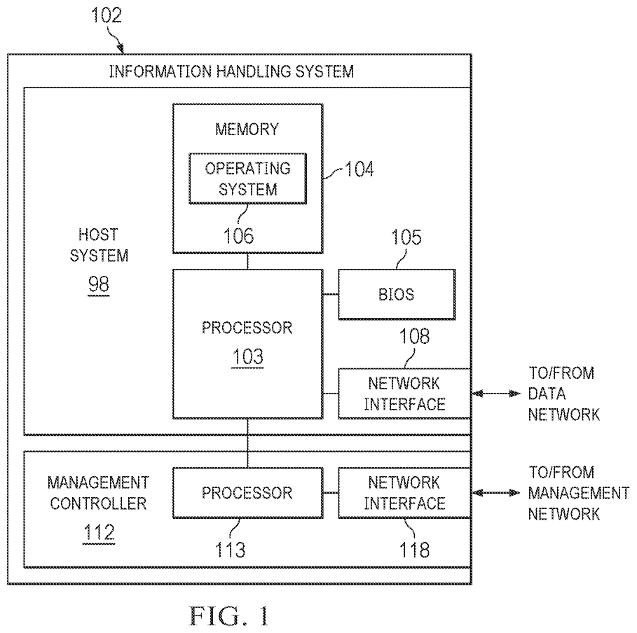

Preferred embodiments and their advantages are best understood by reference to FIGS. 1 through 3, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives, solid-state drives, and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure provide improvements in the field of managing version compatibility issues.

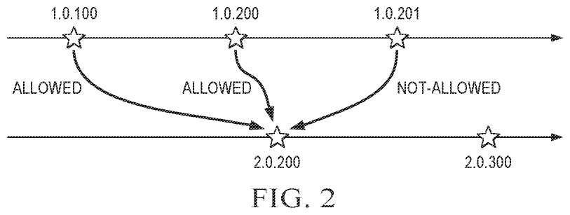

FIG. 2 provides an example of an upgrade scenario for a particular component, with time increasing from left to right. As is sometimes the case, there are multiple active “trains” of releases that are concurrently in development for this component. That is, the train for major version 1 continues in development (e.g., receiving at least security patches) even after major version 2 has been released. Only specific valid upgrade paths are possible, and so an upgrade management system may enforce constraints when a user attempts to install an upgrade from a source version to a target version. For example, in the embodiment of FIG. 2, an upgrade management system may associate a component with each target release that specifies exactly which source releases can be upgraded to that target.

In general, the upgrade management system may be implemented as software, firmware, hardware, or any combination thereof. The upgrade management system may execute on the system being upgraded, on the system providing upgrades, or on any other suitable information handling system.

In the example of FIG. 2, in the 1.0 train, version 1.0.100 was released in January, and 1.0.200 was released in February.

In the 2.0 train, version 2.0.200 was then released in March. When version 2.0.200 was released, it included a component for the upgrade management system that indicated that the only allowed upgrade paths to 2.0.200 were from 1.0.100 and 1.0.200.

Later, version 1.0.201 was released in April. Version 1.0.201 may be, for example, a minor but critical bug fix based on version 1.0.200. In fact, version 1.0.201 can be upgraded to version 2.0.200, and this may be an upgrade path that the user desires. However, because version 2.0.200 was already shipped prior to the release of 1.0.201, there is no way to edit the upgrade management component in 2.0.200 that specified that the only allowed upgrade paths were from 1.0.100 and 1.0.200.

Accordingly, the upgrade path from 1.0.201 to 2.0.200 is blocked, even though it would actually have worked.

Accordingly, some embodiments of this disclosure improve on the “unidirectional” situation of FIG. 2 by providing bidirectional version control information. A release may specify its “allowed source releases” (ASR), indicating which existing releases can be upgraded to it; the release may also specify its “allowed target releases” (ATR), indicating which releases it can be upgraded to. The ASR and ATR information may be stored as a list or any other suitable data structure. In situations where no information is available for an ASR or ATR list, the data structure may be initialized to “null” or any other suitable placeholder value.

Then when trying to upgrade from Release A to Release B, an upgrade management system may perform two checks. In check one, it may determine whether Release A is in Release B's ASR list. In check two, it may determine whether Release B is in Release A's ATR list. Then if either check passes, the upgrade is allowed. If both checks fail, the upgrade is disallowed.

It should be noted that although the two checks are referred to herein as “one” and “two,” they may take place in any desired order in specific implementations. Further, in some implementations, once either of the checks has passed, the other may be omitted.

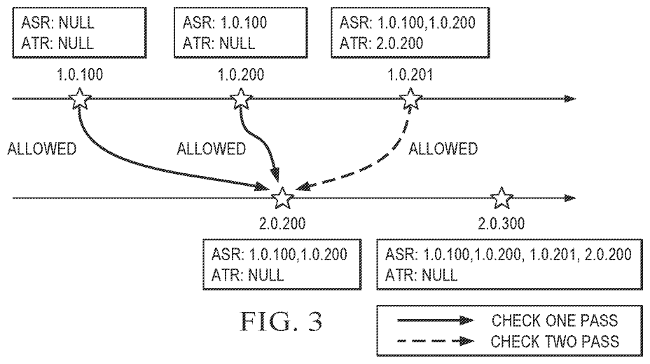

FIG. 3 provides an example of the upgrade scenario of FIG. 2, but using a bidirectional upgrade management system as described herein.

When version 2.0.200 is released, versions 1.0.100 and 1.0.200 have both already been released. Both 1.0.100 and 1.0.200 can be upgraded to 2.0.200, and so the ASR list included in version 2.0.200 is set to [1.0.100, 1.0.200] to indicate that both of those versions can be upgraded to 2.0.200.

When 1.0.201 is subsequently released, it is known that upgrading from 1.0.201 to 2.0.200 is a valid upgrade path. But as discussed above, there is no opportunity to change the data included in version 2.0.200, because that data has already been released. Accordingly, to allow this upgrade path, the ATR list included in version 1.0.201 is set to [2.0.200] to indicate that version 1.0.201 can be upgraded to version 2.0.200.

When a user attempts to upgrade from version 1.0.201 to version 2.0.200, the upgrade management system may perform the following steps.

Check One: Fetch the ASR list for version 2.0.200, which is [1.0.100, 1.0.200]. Because the source version attempting to upgrade to 2.0.200 (1.0.201) is NOT in the ASR list, Check One fails.

Check Two: Fetch the ATR list for version 1.0.201, which is [2.0.200]. Because the target version that is attempting to install (2.0.200) IS in the ATR list, Check Two passes.

The upgrade management system may then allow the upgrade to proceed, because Check Two passes, even though Check One failed. In other situations, the upgrade management system may allow an upgrade to proceed when Check One passes but Check Two fails. In yet other situations, the upgrade management system may allow an upgrade to proceed when both Check One and Check Two pass. In general, the upgrade management system should only disallow the upgrade if both Check One and Check Two fail.

Although various possible advantages with respect to embodiments of this disclosure have been described, one of ordinary skill in the art with the benefit of this disclosure will understand that in any particular embodiment, not all of such advantages may be applicable. In any particular embodiment, some, all, or even none of the listed advantages may apply.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Unless otherwise specifically noted, articles depicted in the drawings are not necessarily drawn to scale. However, in some embodiments, articles depicted in the drawings may be to scale.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory;
wherein the information handling system is configured to:
receive a request to upgrade a component from a first version to a second version;
perform a first check by determining if allowed source release (ASR) information of the second version includes a reference to the first version;
perform a second check by determining if allowed target release (ATR) information of the first version includes a reference to the second version; and
in response to either of the first check and the second check being successful, perform the component upgrade.

2. The information handling system of claim 1, wherein the component is a component of the information handling system.

3. The information handling system of claim 1, wherein the component is a component of a different information handling system.

4. The information handling system of claim 1, wherein the component is a software application.

5. The information handling system of claim 1, wherein the first check takes place prior to the second check.

6. The information handling system of claim 1, wherein, in response to a particular one of the first check and the second check being successful, the information handling system is configured to omit a remaining one of the first check and the second check.

7. A method comprising:
an information handling system receiving a request to upgrade a component from a first version to a second version;
the information handling system performing a first check by determining if allowed source release (ASR) information of the second version includes a reference to the first version;
the information handling system performing a second check by determining if allowed target release (ATR) information of the first version includes a reference to the second version; and
in response to either of the first check and the second check being successful, the information handling system performing the component upgrade.

8. The method of claim 7, wherein the component is a component of the information handling system.

9. The method of claim 7, wherein the component is a component of a different information handling system.

10. The method of claim 7, wherein the component is a software application.

11. The method of claim 7, wherein the first check takes place prior to the second check.

12. The method of claim 7, wherein the second check takes place prior to the first check.

13. An article of manufacture comprising a non-transitory, computer-readable medium having computer-executable code thereon that is executable by a processor of an information handling system for:
receiving a request to upgrade a component from a first version to a second version;
performing a first check by determining if allowed source release (ASR) information of the second version includes a reference to the first version;
performing a second check by determining if allowed target release (ATR) information of the first version includes a reference to the second version; and
in response to either of the first check and the second check being successful, performing the component upgrade.

14. The article of claim 13, wherein the component is a component of the information handling system.

15. The article of claim 13, wherein the component is a component of a different information handling system.

16. The article of claim 13, wherein the component is a software application.

17. The article of claim 13, wherein the first check takes place prior to the second check.

18. The article of claim 17, wherein, in response to a particular one of the first check and the second check being successful, the information handling system is configured to omit a remaining one of the first check and the second check.
